(19) United States
(12) Patent Application Publication
(10) Pub. No.: US 2007/0261185 A1
(43) Pub. Date: Nov. 15, 2007

(54) METHOD AND APPARATUS FOR PROVIDING AUTOMATED INSTRUCTIONS FOR MAINTAINING ORAL HYGIENE

(76) Inventors: Ali G. Guney, Reston, VA (US); Siros Arefi, Potomac, MD (US); Bahram Nasehi, Gaithersburg, MD (US)

Correspondence Address: DITTHAVONG MORI & STEINER, P.C., 918 Prince St., Alexandria, VA, 22314, US

(21) Appl. No.: 11/747,551

(22) Filed: May 11, 2007

Related U.S. Application Data
(60) Provisional application No. 60/799,492, filed on May 11, 2006.

(51) Int. Cl. A61C 17/22

(52) U.S. Cl. 15/22.1; 15/105; 132/322; 132/323; 434/263

(57) ABSTRACT

An oral hygiene product for providing a user aural instruction associated with a proper brushing technique. The oral hygiene product may be any dental device capable of providing an effective brushing technique to a user.

### RELATED APPLICATIONS

This application claims the benefit of the earlier filing date under 35 U.S.C. §119(e) of U.S. Provisional Application Ser. No. 60/799,492 filed May 11, 2006, entitled “Method and Apparatus for Providing Automated Instructions for Maintaining Oral Hygiene,” the entirety of which are incorporated by reference.

### BACKGROUND

For individuals, learning proper brushing and flossing technique is critical for good oral hygiene. Several factors are involved in brushing, for example: frequency and regularity of brushing, amount of proper time allocated for brushing, thoroughness of brushing within each part of oral cavity, and proper motions or brush strokes, etc. It is recognized that the effectiveness of brushing and flossing largely depends on applying techniques in which adequate time is spent on teeth within the various regions of the mouth. For children, proper brushing is an even greater challenge in that they lack interest in brushing, viewing such task as undesirable and burdensome. Moreover, it is difficult to teach children to acquire proper oral care habits because of their lack of interest and because the parent may not be fully aware of what is the proper way to brush.

While much effort has been directed to the improvement of oral hygiene products, very little effort has been dedicated to teaching users on the proper brush technique in a manner that encourages users to brush and to learn effective brushing techniques.

Accordingly, there is a need for an approach to permit users to properly practice oral hygiene. There is also a need for a mechanism to encourage users to perform such oral hygiene practices.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIGS. 1A and 1B are diagrams of exemplary toothbrushes capable of conveying instructions for proper brushing techniques, in accordance with an embodiment of the present invention;

FIG. 2 is a diagram showing the delivery of brushing instructions through a speaker, a display and/or a vibration mechanism, according to an embodiment of the present invention;

FIG. 3 is a diagram depicting the regions of the mouth and associated brushing instructions that are conveyed by the toothbrushes of FIGS. 1A and 1B;

FIG. 4 is a diagram of an exemplary circuit for providing the brushing instructions, in accordance with an embodiment of the present invention; and

FIG. 5 is a flowchart for utilizing the toothbrushes of FIGS. 1A and 1B, according to an embodiment of the present invention; and

FIG. 6 is a flowchart for proper brushing instructions, according to an embodiment of the present invention.

### DESCRIPTION OF PREFERRED EMBODIMENTS

The described needs are addressed by various embodiments of the present invention, in which an approach is presented for conveying proper brushing and flossing techniques to the user through an instructive oral hygiene device (e.g., toothbrush or flossbrush). The device, according to one embodiment, provides voice instructions using recognizable characters (e.g., famous cartoon characters in the case of children). This arrangement enables an interactive experience that can increase the users' interests in brushing as well as train these users to achieve proper technique.

Thus, an oral hygiene product and method for providing an instruction of proper brushing technique with an aural user interface is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the oral hygiene product is described in form of a toothbrush, it is noted that the voice instructions can be provided in a separate device (e.g., that can be attached to an existing toothbrush).

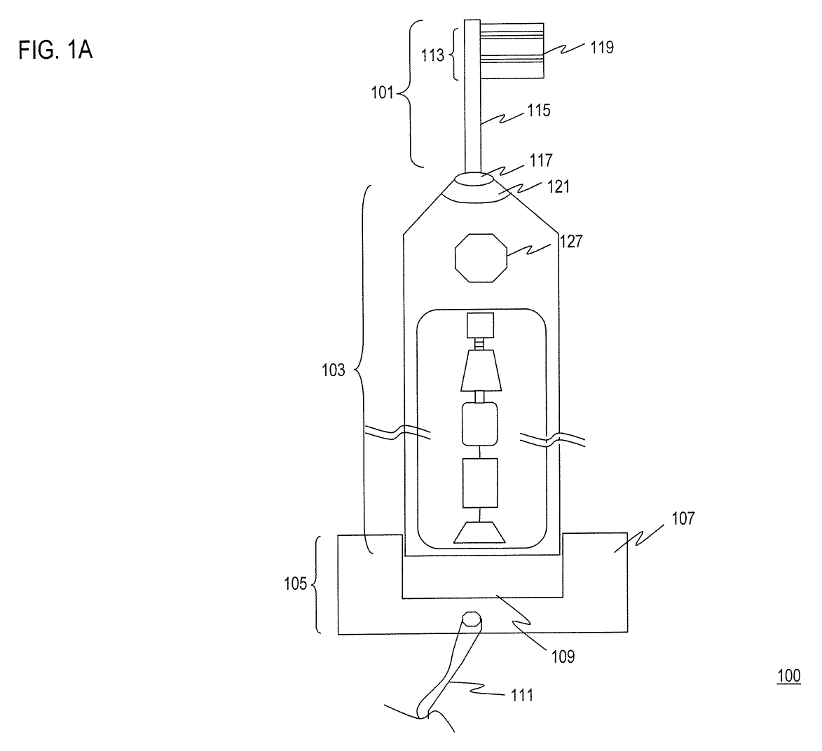

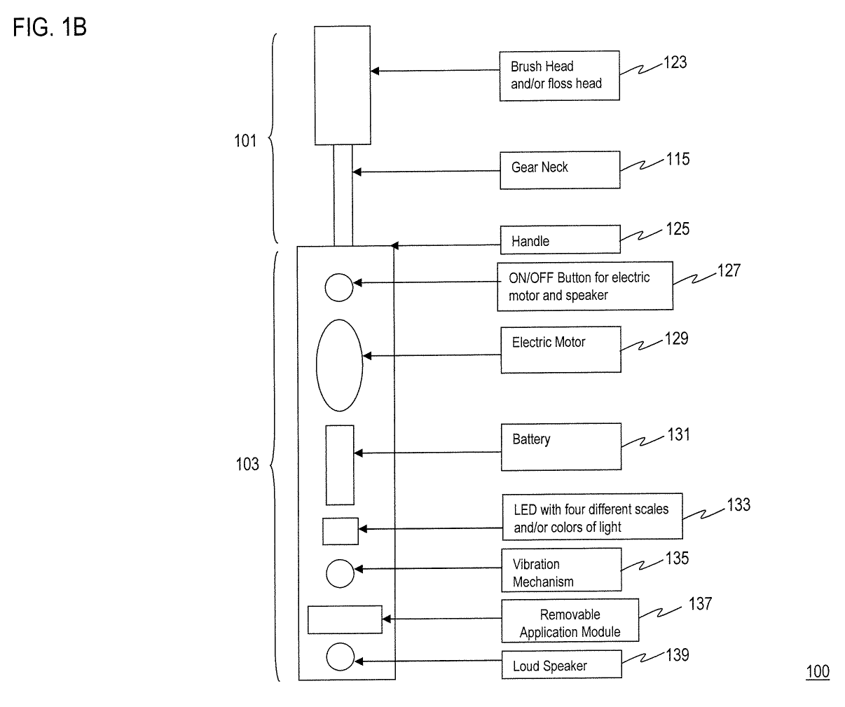

FIGS. 1A and 1B are diagrams of exemplary toothbrushes capable of conveying instructions for proper brushing techniques, in accordance with an embodiment of the present invention. An oral hygiene product 100 includes a fixed or detachable brush assembly 101 and a body 103 of toothbrush and an optional recharging base 105. The recharging base (e.g., AC power source) 105 includes a receiving part 107 having charger contacts 109 and a power line 111. The base 105 can alternatively be a section that houses non-rechargeable batteries (see FIG. 1B). The brush assembly 101 includes a brush head 113 or floss head 123 attached to a shaft portion 115 having a shaft end 117 that fits into a receiving portion 121 of an end of the body 103. The brush head 113 includes a plurality of bristles 119 that are used for tooth brushing. It is contemplated that, in certain embodiment, the brush head 113 is replaceable. Alternatively, the product 100 can be disposable; such that upon depletion of the batteries, the product 100 can simply be discarded.

In one embodiment, the body 103 is a hollowed body formed with a molded plastic housing and a griping portion. The detachable upper cap 121 being detachably to join the brush assembly 101. The brush assembly 101 can optionally be detachable from the body 103 and suitably connected by means of known methods.

The body 103 and the brush head 113 are coupled by a coupling means. The body 103 constitutes a handle 125, and includes contacts 109 for electrical connection with the recharging base 105. The body 103 comprises a mechanism including an On/Off switch 127, a sealed loud speaker 139, an application module 137 (e.g., application specific integrated chipset (ASIC) module), a housing containing a conventional battery pack 131 (DC power source), and a motor 129 (along with a motor driver). In one embodiment, the switch 127 can enable and disable the speaker 139. The body 103 provides a water-resisting housing, in accordance with an exemplary embodiment. Also, it is contemplated that the application module 137 can be a memory device that is removable and replaced with a device specifying instructions with other voices and/or background music.

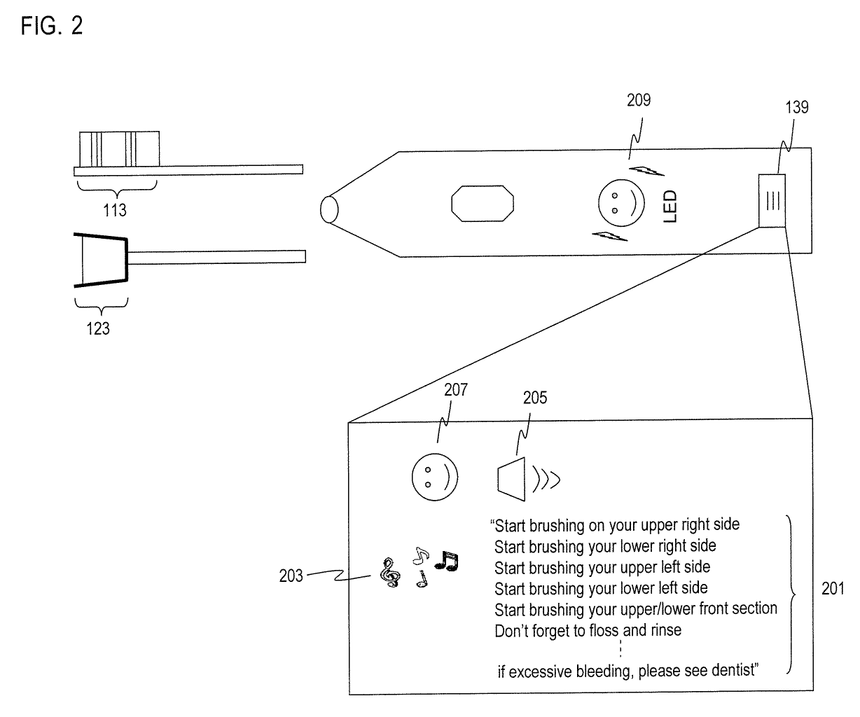

FIG. 2 is a diagram showing the delivery of brushing instructions through a speaker, a display and/or a vibration mechanism, according to an embodiment of the present invention. Instructions 201 for the proper brushing technique, in an exemplary embodiment, are played with music 203 (which can be implemented as an optional preference for the user). The voice signals 205 are pre-recorded according to the preferences of user (e.g., imitation of voice of famous characters, such as well-known cartoon character 207, or a celebrity human voice). This instructional feature can be controlled by a logic in circuit 137, which is activated by pushing an On/Off switch button 127. Further, a display 209 can provide animation of the characters, for instance. The display can be a Liquid Crystal Display (LCD) or a series of Light Emitting Diodes (LEDs) 209.

The instructions 201, including information on hygiene practices relating to pre- and/or post-brushing (e.g., floss, rinse, proper angle of brushing, or a warning message), can be played before, during or after the brushing activity. The warning message, for instance, can alert the user of potential problems, such as excessive bleeding upon brushing, and to seek medical assistance (e.g., contact a dentist).

Further, according to an exemplary embodiment, the music (e.g., theme song) 203 can be played at various points between the voice prompts 201. For example, upon completion of one section, music 203 can be played before the device instructs the user to move on.

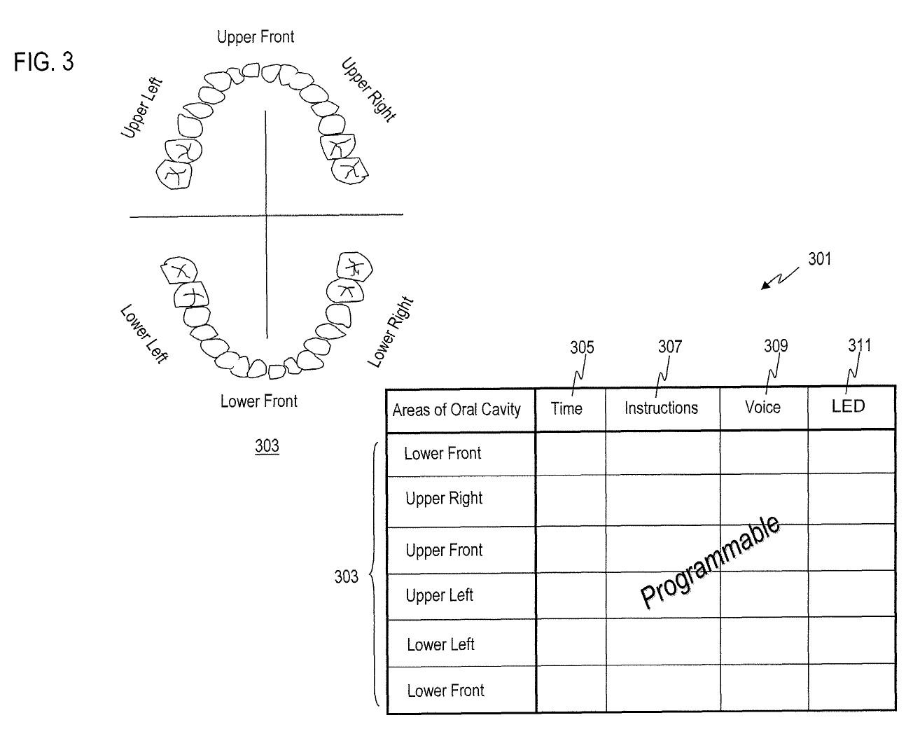

As mentioned, according to one embodiment of the present invention, FIG. 3 illustrates the quadrants 303 or areas of dentition and exemplary programmable contents 301 to be stored memory (not shown). Such contents 301 can include configurable parameters for the particular quadrants 303. By way of example, such parameters include a time field 305 to specify the duration associated with the specific quadrant, an instructions field 307 providing instructions for the quadrant, a voice field 309 to indicate the type of voice signal (e.g., character) for the quadrant, and an LED field 311 to specify whether an LED indicator is used for the quadrant. In this manner, the instructions 307 can be tailored to cover different areas of the mouth (oral cavity) to which cleaning process is applied associated with time 305 assigned to each of the quadrants (or portions) during a brushing activity. The oral cavity (human or otherwise) can conceptually be viewed as the following areas of dentition: upper front, upper right, lower right, lower front, lower left, and upper left. It is noted that the instructions can be recorded in any form as to provide the information to the user in a clear, understandable fashion. Moreover, in addition to or instead of audio instructions, a visual display 209 can be provided to instruct movement from one quadrant to another quadrant.

In one embodiment, light emitting diodes (LEDs) 209 are used to represent respective quadrants 303, wherein the LED 209 that is on is the quadrant the user should be within. Additionally, a vibration mechanism (e.g., vibrator 135) can be implemented within the handle to notify the user to proceed to the next quadrant; this notification can be used individually or in conjunction with the other audio 207 or visual indicators 209.

According to one embodiment, historical and statistical data associated with the brushing habits of the user can be stored in memory. This permits to the user to track the amount of time spent brushing each area, as well as the entire brushing process.

Furthermore, a floss head 123 can be used to supplement the brushing with its own set of instructions, in an exemplary embodiment. For example, such instructions can specify “Thread the floss between your teeth. Do not hit gums. Move the floss up and down while hugging each tooth on the sides. Repeat for the next tooth.”

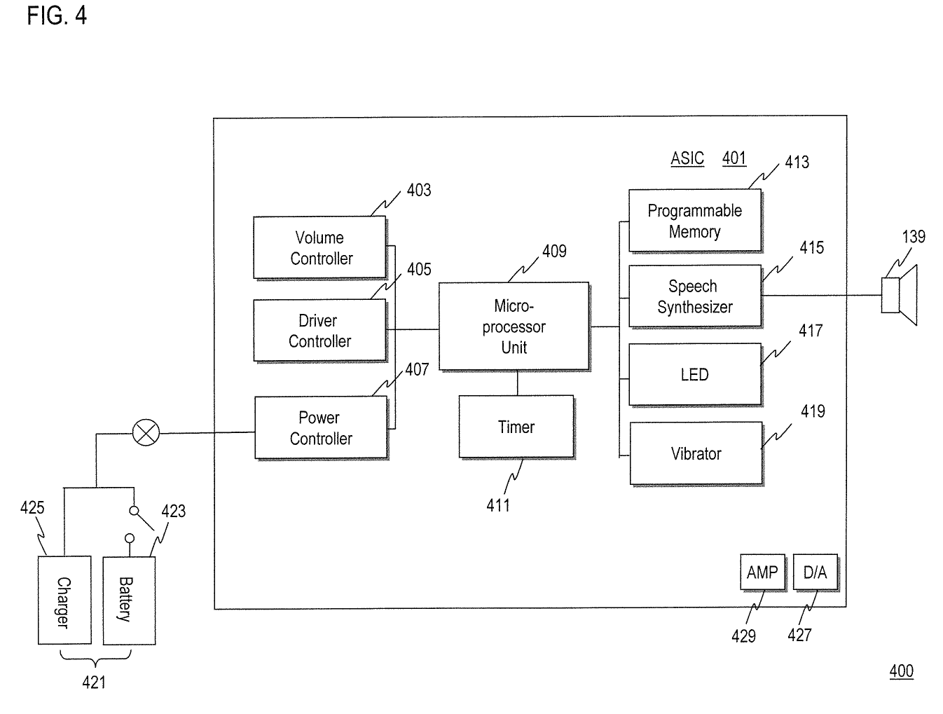

FIG. 4 illustrates exemplary hardware 400 upon which various embodiments of the invention can be implemented. The various digital circuits can be implemented within an Application Specific Integrated Circuit (ASIC) 401 or other type of Printed Circuit Board (PCB) module. The ASIC or PCB module (computing system) includes controllers 403, 405 and 407 to control mechanism for communicating signal by a microprocessor unit 409 coupled to the timer 411 for processing signal.

The computing system also includes programmable memory, such as a programmable read-only memory (PROM) 413 or other storage device, coupled to the bus for storing information and instructions 307 to be executed by the microprocessor unit 409. The computing system 400 also includes a power controller 407 coupled to a power supply source 421. Energy source 421 is generated optionally either by means of a typical 1.5 V battery 423 or as shown here by a charger 425. Energy source 421 actuates a driver controller 405 which connects to a motor to control a generating speed. The computing system 400 may be coupled via the bus to the power controller 407.

In the illustrated embodiment, a microprocessor unit 409 can actuate a signal to control controllers (volume 403, driver 405 and power 407). A number of instructions by various character voices can be stored in the programmable memory 413. The control means in the forms of pushing switch, voice activation, motion activation etc. can be used. Such control is operatively connected to a memory.

The timer circuit is activated by a switching mechanism controlled by the microprocessor unit. When the On/Off switch 127 is detected, the clock is started and an audio signal is selected and played. The instructions 307 is determined by a timer 411 in a pre-determined time detected by the microprocessor 409, and the instructions 307 are transferred into a speaker 139 in a given time interval. The processor unit 409 is preferably triggered by varying time to ensure that each section of the mouth (i.e., areas of dentition) is brushed for the specified amount of time. An electrical signal is converted into desirable human voice or famous character voice using a speech synthesizer 415. An LED 417 and a vibrator 419 are also provided to communicate information to the user.

It is further appreciated that microprocessor unit 409 can control a driver controller 405 according to pre-programmed 301 to adjust speed of motor and to change the direction of movement, thereby optimally setting for actuating bristle head 113 or floss head 123 during the brushing and flossing activity. Power controller 407 examines strength or weakness of power to supply constant signal to circuits. The microprocessor unit 409 can change the direction of movement when the head 113, 123 is replaced.

A digital voice synthesizer 415 for cleaning voice instructions is connected to the speaker 139 via D/A converter 427. An amplifier 429 amplifies the instructions (and/or musical signal) and for aural delivery through the speaker 139.

The power controller 407 includes a sensor to detect a charger 425 whether sufficient amount of the power to generate a system. If so, the power controller 407 selectively receives a power only from a charger 425. If the power generated by the charger 425 is detected as weak by the sensor, the microprocessor unit 409 commands to receive the power from battery 423 to the power controller 407.

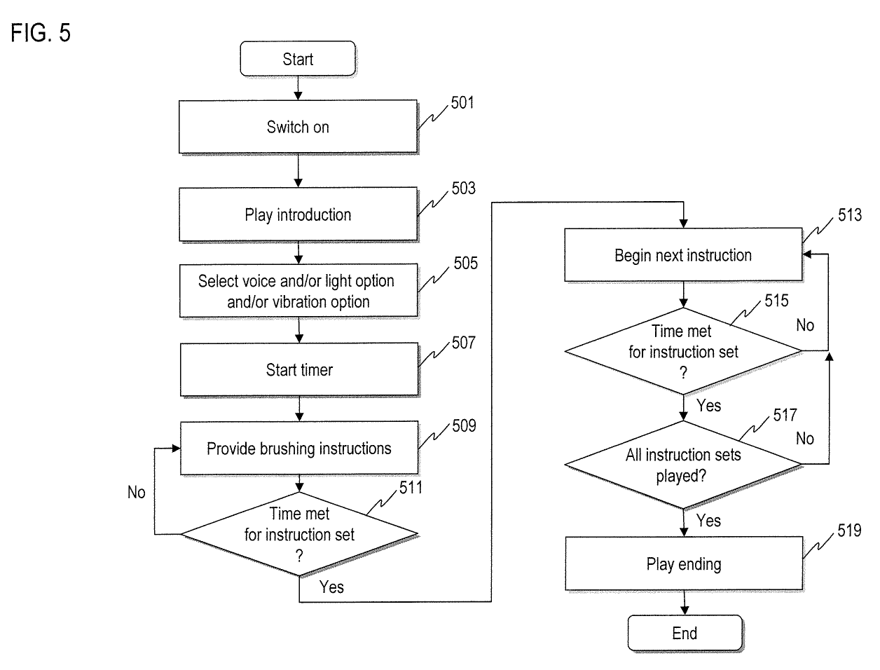

FIG. 5 shows a flowchart for utilizing the toothbrushes of FIGS. 1A and 1B, according to an embodiment of the present invention. By way of example, per step 501, a user switches on the oral hygiene product 100. Upon activating the switch (step 501) an introduction can be played, per step 503. Next, the user, per step 505, can select a means (e.g., any one or combination of audio, visual or vibrating indicators) for receiving proper instructions. A timer is thus started, per step 507.

In step 509, brushing instructions are provided by way of the selected means to the user. When a set time is met (as determined in step 511), the oral hygiene product 100 automatically plays the next instruction, as in step 513, until all instruction sets are played (steps 515 and 517). Thereafter, in step 519, upon completion of all the instructions, an optional ending is played to notify the user that the cleaning is complete.

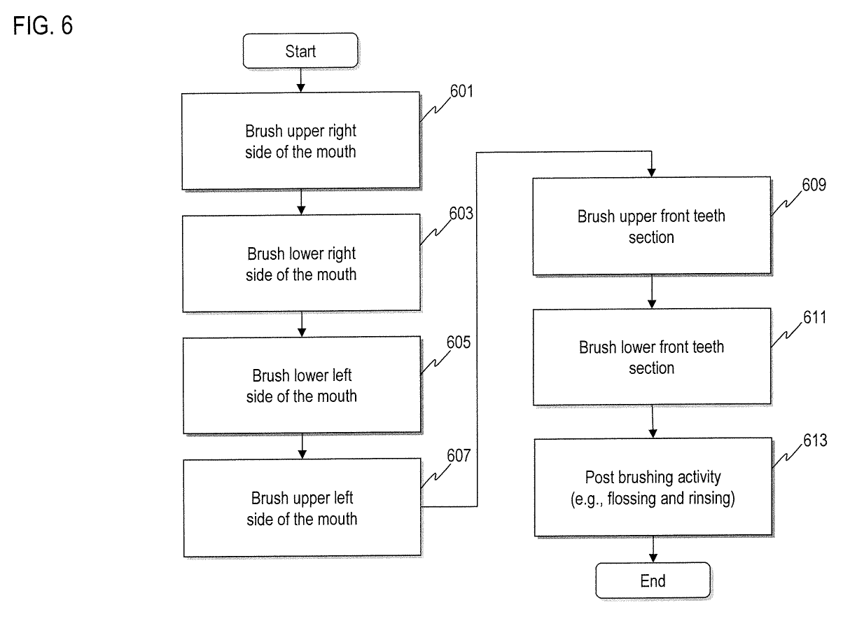

FIG. 6 is a flowchart for proper brushing instructions, according to an embodiment of the present invention. The brushing instructions programmed based on the quadrants or areas of detention of FIG. 3 can be time regulated using a timer circuit configured to assign each set of the instruction to a predetermined duration. By way of example, the instructions can be sequentially played per steps 601-611. In step 613, the instructions can cover post brushing activity such as flossing, rinsing and including providing a warning message.

According to various embodiments of the invention, the processes described herein can be provided by the computing system in response to the processor executing an arrangement of instructions contained in main memory. Execution of the arrangement of instructions contained in memory causes the processor to perform the process steps described herein. One or more processors in a multi-processing arrangement may also be employed to execute the instructions contained in main memory.

In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

A series of sequential data of instructions according to the time sequence are triggered by a timer to provide a user with an immediate instruction. The duration of the instructional session coordinated with time recommended based on each portions of the mouth. Using algorithm programmed on memory, each step of the instructions can be played through speaker.

One of ordinary skill in the art would recognize that the processes for providing instructions within the oral hygiene product can implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Common forms of computer-readable media that can store the instructions include, for example, a RAM, a PROM, and EPROM, a FLASH-EPROM, any other memory chip or cartridge, or any other medium from which a computer can read.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. An apparatus for providing oral hygiene, the apparatus comprising:
a head; and
a body coupled to the head, the body housing,
an application module configured to store oral hygiene instructions, and
at least one of a speaker, a display, or a vibration mechanism configured to convey the stored oral hygiene instructions,
wherein the oral hygiene instructions specify brushing or flossing within one region of a mouth of a user for a configurable duration and then moving to another region of the mouth according to a predetermined scheme.

2. An apparatus according to claim 1, wherein the application module is configured to play music through the speaker concurrently with the instructions.

3. An apparatus according to claim 2, wherein the music is preprogrammed in the application module.

4. An apparatus according to claim 1, wherein the speaker outputs an audio signal representing a voice of a famous character or a human celebrity.

5. An apparatus according to claim 1, wherein the display includes a liquid crystal display (LCD) or a light emitting device (LED).

6. An apparatus according to claim 1, wherein the apparatus is disposable.

7. An apparatus according to claim 1, wherein the head includes a bristle or a dental floss.

8. An apparatus according to claim 1, wherein the instructions specify proper angle of brushing, duration of brushing for respective quadrants of dentition, or pre- and post-brushing activity including flossing, rising and providing a warning message.

9. A method comprising:
programming oral hygiene instructions into an application module that is configured to be inserted into a housing of a battery-operated oral hygiene tool,
wherein the oral hygiene instructions specify brushing or flossing within one region of a mouth of a user for a configurable duration and then moving to another region of the mouth according to a predetermined scheme.

10. A method according to claim 9, wherein the application module is configured to play music, through a speaker within the housing, concurrently with the instructions.

11. A method according to claim 10, wherein the music is preprogrammed in the application module.

12. A method according to claim 10, wherein the oral hygiene tool includes a speaker, a display and a vibration mechanism configured to convey the oral hygiene instructions, the speaker outputting an audio signal representing a voice of a famous character or a human celebrity.

13. A method according to claim 12, wherein the display includes a liquid crystal display (LCD) or a light emitting device (LED).

14. A method according to claim 9, wherein the oral hygiene tool is disposable.

15. A method according to claim 9, wherein the oral hygiene tool further includes head that includes a bristle or a dental floss.

16. A method according to claim 9, wherein the instructions specify proper angle of brushing, duration of brushing for respective quadrants of dentition, or pre- and post-brushing activity including flossing, rising and providing a warning message.

17. A toothbrush device comprising:
a head; and
a body coupled to the head, the body housing,
a driver shaft to which the head is coupled,
a motor driver connected to the driver shaft for driving the head,
a motor connected to the motor driver,
a power source for supplying power to the motor,
an application module configured to store oral hygiene instructions, and
at least one of a speaker, a display, or a vibration mechanism configured to convey the stored oral hygiene instructions,
wherein the oral hygiene instructions specify brushing or flossing within one region of a mouth of a user for a configurable duration and then moving to another region of the mouth according to a predetermined scheme.

18. A device according to claim 17, wherein the application module is configured to play music through the speaker concurrently with the instructions.

19. An apparatus according to claim 17, wherein the music is preprogrammed in the application module.

20. An apparatus according to claim 17, wherein the speaker outputs an audio signal representing a voice of a famous character or a human celebrity.
